(19) United States
(12) Patent Application Publication
(10) Pub. No.: US 2011/0246312 A1
(43) Pub. Date: Oct. 6, 2011

(54) ADVERTISEMENT INVENTORY MATCHING

(75) Inventors: Christopher A. Meek, Kirkland, WA (US); Denis X. Charles, Bellevue, WA (US); Nikhil Devanur Rangarajan, Redmond, WA (US); David M. Chickering, Bellevue, WA (US); Manan Sanghi, Bellevue, WA (US); Kamal Jain, Bellevue, WA (US)

(73) Assignee: MICROSOFT CORPORATION, Redmond, WA (US)

(21) Appl. No.: 12/751,533

(22) Filed: Mar. 31, 2010

(51) Int. Cl. G06Q 30/00

(52) U.S. Cl. 705/14.73; 705/14.4

(57) ABSTRACT

Various embodiments provide techniques for advertisement inventory. In at least some embodiments, a scaled number of impressions can be matched to orders that have scaled impression goals. Impressions can be randomly selected from an offline traffic model and allocated to orders according to a matching algorithm until a number of impression defined by a scale factor is reached. This can occur by sampling the traffic model directly using the scale factor and/or by creating a scaled data set to which the matching algorithm can be applied. The matching algorithm can be configured to identify an order that is farthest away from being complete and then match the randomly selected impression to the identified order. If the scaled orders in the data set can be fulfilled using the scaled number of impressions, a conclusion is made that the original set of orders can be fulfilled using the original impressions.

### BACKGROUND

In one form of online advertising, advertisers buy display ads (e.g., graphical “banner” ads) to be shown to users in conjunction with online resources available from service providers. The service providers are compensated an amount for each web-page impression (e.g., user view of a page) for which an advertisement is shown. Display ads are typically sold with guaranteed impression goals. In this scenario, the service provider sells orders for a fixed number of impressions and is responsible for making sure that the goals for the orders are met. In this context, the service provider may be concerned with matching of various orders to impressions in a manner that increases revenue and fulfills all the orders. Such matching may be used for determining when orders can be booked as well as for deciding how to optimally deliver ads online.

Matching of this type, though, can become quite difficult as the number of advertisers and/or impressions to be matched becomes larger due to the number of computations involved in performing the matching. Thus, traditional algorithms suitable to perform matching with relatively small data sets may be unable to successfully perform matching for larger data sets that arise in some scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques for advertisement inventory matching. In one or more embodiments, a set of orders and impressions from an offline traffic model are both scaled by a scale factor to match a scaled number of impressions to orders that have scaled impression goals. Impressions from the data set can be randomly selected from the traffic model and allocated to orders according to a matching algorithm until a number of impression defined by the scale factor is reached. This can occur by sampling the traffic model directly using the scale factor and/or by creating a scaled data set to which the matching algorithm can be applied. In at least some embodiments, the matching algorithm is configured to identify an order that is farthest away from being complete and then match the randomly selected impression to the identified order. If the scaled orders in the data set can be fulfilled using the scaled number of impressions, a conclusion is made that the original (e.g., un-scaled) set of orders can be fulfilled using the original (e.g., un-scaled) impressions.

In one or more embodiments, a linear program is defined to represent scaled impressions and scaled orders based at least in part upon a traffic model. The linear program is utilized to derive priorities for the orders by optimizing a dual of the linear program. The priorities that are derived offline are then utilized to allocate impressions to orders online.

### BRIEF DESCRIPTION OF THE DRAWINGS

FIG. 1 illustrates an example operating environment in which one or more embodiments of advertisement inventory matching can be employed.

FIG. 2 is a flow diagram that describes an example procedure in accordance with one or more embodiments.

FIG. 3 is a flow diagram that describes details of an example matching algorithm in accordance with one or more embodiments.

FIG. 4 is a flow diagram that describes details of an example matching algorithm in accordance with one or more embodiments.

FIG. 5 is a flow diagram that describes details of an example matching algorithm in accordance with one or more embodiments.

FIG. 6 is a block diagram of a system that can implement the various embodiments.

### DETAILED DESCRIPTION

Overview

Various embodiments provide techniques for advertisement inventory matching. In one or more embodiments, a set of orders and impressions from an offline traffic model are both scaled by a scale factor to match a scaled number of impressions to orders that have scaled impression goals. Impressions from the data set can be randomly selected from the traffic model and allocated to orders according to a matching algorithm until a number of impression defined by the scale factor is reached. This can occur by sampling the traffic model directly using the scale factor and/or by creating a scaled data set to which the matching algorithm can be applied. In at least some embodiments, the matching algorithm is configured to identify an order that is farthest away from being complete and then match the randomly selected impression to the identified order. If the scaled orders in the data set can be fulfilled using the scaled number of impressions, a conclusion is made that the original (e.g., un-scaled) set of orders can be fulfilled using the original (e.g., un-scaled) impressions.

In one or more embodiments, a linear program is defined to represent scaled impressions and scaled orders based at least in part upon a traffic model. The linear program is utilized to derive priorities for the orders by optimizing a dual of the linear program. The priorities that are derived offline are then utilized to allocate impressions to orders online.

In the discussion that follows, a section entitled “Operating Environment” describes but one environment in which the various embodiments can be employed. Following this, a section entitled “Advertisement Inventory Matching Procedures” describes example techniques for advertisement inventory matching in accordance with one or more embodiments. Next, a section entitled “Advertisement Inventory Matching Implementation Details” describes example algorithms and implementations for advertisement inventory matching in accordance with one or more embodiments. Last, a section entitled “Example System” is provided and describes an example system that can be used to implement one or more embodiments.

Operating Environment

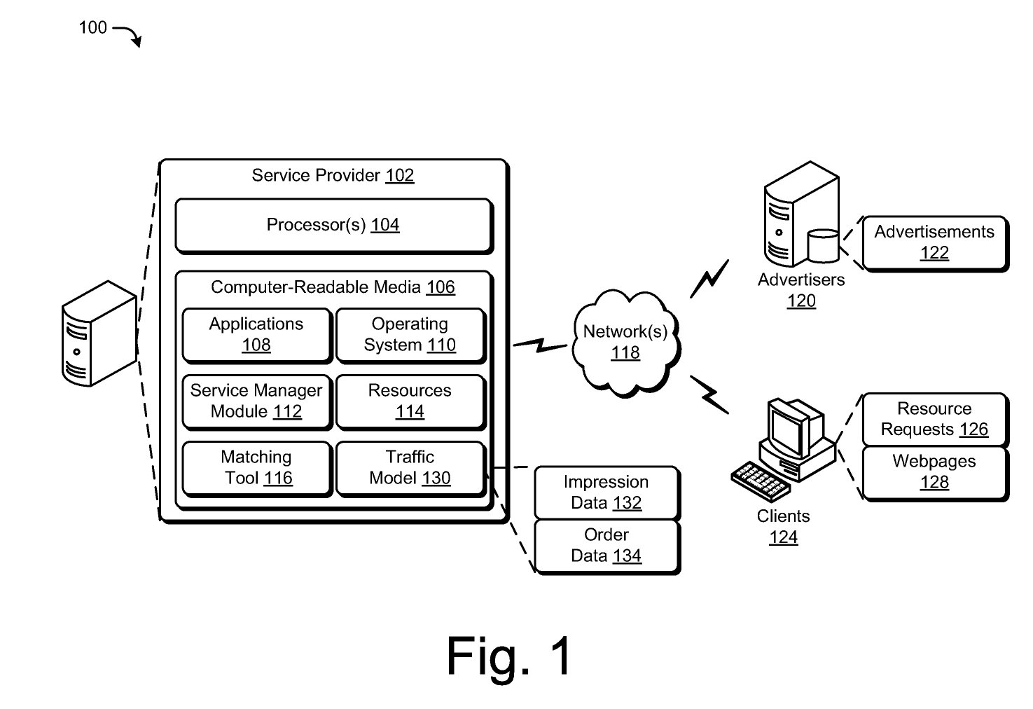

FIG. 1 illustrates an operating environment in accordance with one or more embodiments, generally at 100. Environment 100 includes a service provider 102 having one or more processors 104, one or more computer-readable media 106 and one or more applications 108 that are stored on the computer-readable media and which are executable by the one or more processors 104. The computer-readable media 106 can include, by way of example and not limitation, all forms of volatile and non-volatile memory and/or storage media that are typically associated with a computing device. Such media can include ROM, RAM, flash memory, hard disk, optical disks, removable media, and the like. Computer-readable media 106 is also depicted as storing an operating system 110, a service manager module 112, resources 114 (e.g., content, services, and data), and a matching tool 116 that may also be executable by the processor(s) 104. While illustrated separately, the matching tool 116 may also be implemented as a component of the service manager module 112.

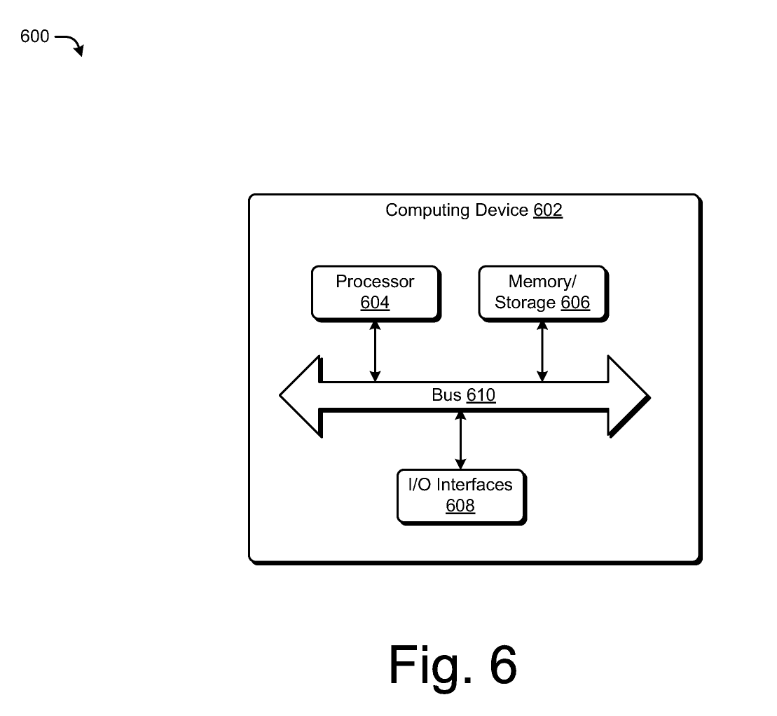

Service provider 102 can be embodied as any suitable computing device or combination of devices such as, by way of example and not limitation, a server, a server farm, a peer-to-peer network of devices, a desktop computer, and the like. One specific example of a computing device is shown and described below in relation to FIG. 6. Service provider 102 can be communicatively coupled over a network 118 to various other entities (e.g., devices, servers, storage locations, clients, and so forth). In particular, service provider 102 is illustrated as being connected over the network 118 to advertisers 120 that provide advertisements 122 and clients 124. Advertisers 120 and clients 124 may interact over the network 118 with the service provider 102 to obtain access to various resources 114. Although the network 118 is illustrated as the Internet, the network may assume a wide variety of configurations. For example, the network 118 may include a wide area network (WAN), a local area network (LAN), a wireless network, a public telephone network, an intranet, and so on. Further, although a single network 118 is shown, the network 118 may be configured to include multiple networks.

Service manager module 112 represents functionality operable by service provider 102 to manage various resources 114 that may be made available over the network 118. Service manager module 112 may manage access to the resources 114, performance of the resources 114, configuration of user interfaces or data to provide the resources 114, and so on. For example, clients 124 may form resource requests 126 for communication to the service provider 102 to obtain corresponding resources 114. In response to receiving such requests, service provider 102 can provide various resources 114 via webpages 128 and/or other user interfaces that are communicated over the network 118 for output by the one or more clients 124.

Resources 114 can include any suitable combination of content and/or services typically made available over a network by one or more service providers. Content can include various combinations of text, video, ads, audio, multi-media streams, animations, images, and the like. Some examples of services include, but are not limited to, a search service, an email service to send and receive email, an instant messaging service to provide instant messages between clients, and a social networking service to facilitate connections and interactions between groups of users who share common interests and activities. Services may also include an advertisement service configured to enable advertisers 120 to place advertisements 122 for presentation to clients 104 in conjunction with the resources 114.

For instance, at least some of the webpages 128 can be configured to include advertisements 122 provided by the advertisers 120. Advertisements 122 may be selected for inclusion in webpages through an advertisement service using any suitable techniques for selection and delivery of the ads. In one example, auctions may be conducted for space that is reserved in a webpage 128 for advertisements 122 from the advertisers 120. Further, booking of orders for ads and delivery of the ads may occur in accordance with advertisement inventory matching techniques described herein.

The matching tool 116 is configured to implement aspects of matching techniques described herein. The matching techniques can be employed in the context of matching advertisement inventory, as well as for various other matching problems. To perform matching, the matching tool 116 may be configured to make use of a traffic model 130 that represents various data related to interaction of the service provider 102 with clients 124 and/or advertisers 120. Such data may be collected, stored, and/or accessed via the service provider 102. Although the example traffic model 130 of FIG. 1 is illustrated as being stored on computer-readable media 106 of the service provider 102, it is contemplated that data related to the traffic model 130 may be compiled, stored, and/or obtained by way of any suitable local or network storage location and/or device.

In the example of FIG. 1, the traffic model 130 is illustrated as including impression data 132 and order data 134. Impression data 132 can include data related to client interaction with the service provider 102 such as search queries, page views, click patterns, keyword statistics, and so forth. Order data 134 can include data describing actual and/or simulated orders from advertisers 122, bids for ad auctions, order priorities, delivery schedules, and so forth. Traffic model 130 may also include various other data to facilitate matching including but not limited to priorities for bids, orders, and/or advertisers 120 that are derived in accordance with matching techniques described herein.

More particularly, the matching tool 116 represents functionality operable to at least obtain a suitable data set and/or graph to represent a matching problem, sample and/or scale the data according to a scale factor to reduce the matching problem, and apply various matching algorithms to the sampled data and/or otherwise perform analysis to solve the matching problem. The matching tool 116 can make use of conclusions made for the sampled data set to draw corresponding conclusions for the un-scaled data set. In the context of advertisement inventory this can involve matching of orders described by the order data 134 with impressions described by the impression data 132. The matching tool 116 may be implemented to enable advertisement inventory matching through offline simulations using the traffic model 130 and/or online using actual traffic (e.g., actual orders and impressions). Offline simulations for matching can be employed at a time when orders are being processed to make determination regarding whether inventory is sufficient to allow the orders to be booked. Additionally or alternatively, online matching can be used to determine how to efficiently deliver advertisements to actual impressions to fulfill corresponding orders. Further discussion of matching techniques that may be implemented by way of the matching tool 116 can be found in relation to the following figures.

Having considered an example operating environment, consider now a discussion of example advertisement inventory matching techniques in accordance with one or more embodiments.

Advertising Inventory Matching Procedures

The following discussion describes matching techniques that may be implemented utilizing the environment, systems, and/or devices described above and below. Aspects of each of the procedures below may be implemented in hardware, firmware, software, or a combination thereof As discussed in detail herein, offline simulations for matching can be employed at a time when orders are being processed to make determinations regarding whether inventory is sufficient to allow the orders to be booked. Such simulations can also be used to compute a delivery schedule that may be employed to allocate impressions to actual orders. Additionally or alternatively, online matching can be used to determine how to efficiently deliver actual impressions online to fulfill corresponding orders. The following procedures are shown as a set of blocks that specify operations performed by one or more devices and are not necessarily limited to the orders shown for performing the operations by the respective blocks. In portions of the following discussion, reference may be made to the example environment 100 of FIG. 1.

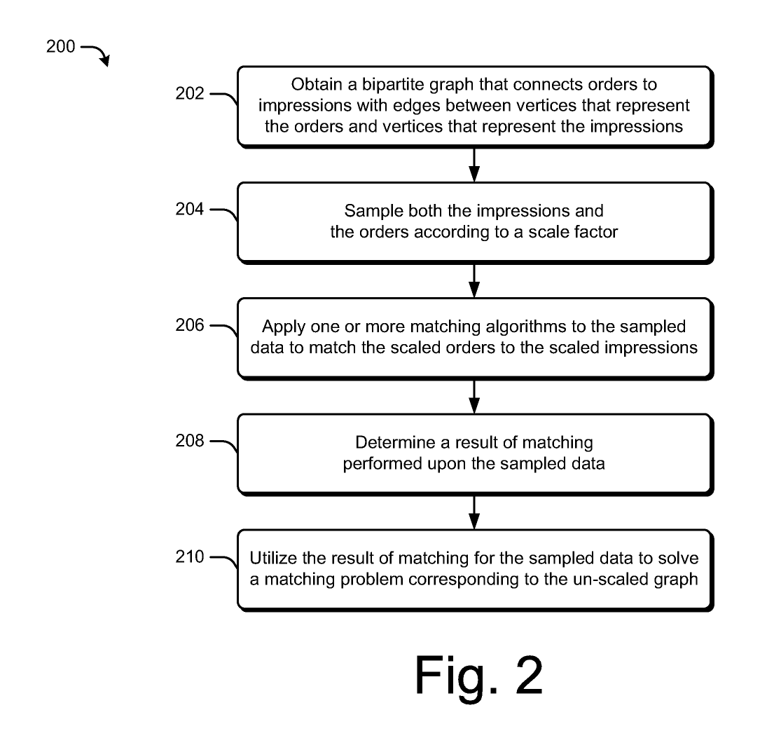

FIG. 2 is a flow diagram that describes an example procedure 200 in accordance with one or more embodiments. In at least some embodiments, the procedure 200 can be performed by a suitably configured computing device, such as a service provider 102 of FIG. 1, or other computing device having a matching tool 116.

Step 202 obtains a bipartite graph that connects orders to impressions with edges between vertices that represent the orders and vertices that represent the impressions. One way this can occur is by operation of matching tool 116 to construct a graph using impression data 124. Additionally or alternatively, matching tool 116 may be configured to receive a previously constructed graph as input from any suitable source. Matching tool 116 may then operate to perform matching techniques on the obtained graph using various matching algorithms.

A graph (G) as used herein generally refers to a structure consisting of a set of vertices (V) and a set of edges (E) used to represent relationships between the vertices. For instance, a graph can be used to relate entities one to another based upon common conditions, properties, parameters, characteristics, activities, connections, and so forth. A bipartite graph is a graph that has two types of vertices and edges that connect vertices of distinct types. In the context of inventory for ads associated with resources 114 from a service provider 102, a bipartite graph is a structure that contains vertices (O) representing orders and vertices (I) representing impressions that are joined by edges (E) when an order targets an impression to which it is joined. In other words, there is an edge between an impression i ∈ I and order o ∈ O if the impression satisfies the targeting criteria of the order.

A matching for the bipartite graph provides an assignment of impressions to orders in a way that an impression is matched to at most one order. A maximum matching in the impression-order graph maximizes the number of matches such that inventory is allocated efficiently, the number of orders booked is optimal, and the amount of under-delivery to orders at delivery time is minimized. Even using the bipartite graph, though, matching problems of this type can become quite difficult and computationally expensive as the number of advertisers and/or impressions to be matched becomes larger. Accordingly, in lieu of analyzing the entire bipartite graph and/or corresponding data set, matching techniques are described herein that create and/or makes use of sampled and/or scaled graph data to simplify the matching problem.

In particular, step 204 samples both the impressions and the orders according to a scale factor. As noted, a data set can be too large in size to permit efficient analysis. Accordingly, to enable more efficient analysis, the matching tool 116 may be implemented to make use of a relatively smaller sample of the data set and/or create a scaled version of the data set and/or a corresponding graph that is easier to work, and involves less computations to analyze. This approach can involve sampling a fraction of the impressions according to their distribution using a scale factor ∈ and scaling the impression goals of the orders using the same scale factor ∈. This can occur by directly sampling impressions from the traffic model 130 until a target number of impressions defined by the scale factor ∈ is reached. Additionally or alternatively, the sampling can occur by creating a smaller (e.g., scaled) bipartite graph on which to solve the matching problem. Generally speaking, the sampled data can be obtained by scaling impression goals of orders according to the scale factor ∈. The traffic model 130 as discussed in relation to FIG. 1 may then be used to obtain a sampled number of impressions that is determined according to the scale factor ∈.

The size of the scale factor ∈ can be selected to ensure that a matching solution for the sampled data and/or scaled graph indicates with a high confidence that a matching solution exists for the un-scaled graph. Consider an un-scaled graph having m impressions and n orders, and suppose Δ represents the minimum degree of an order. If a scale factor ∈ is applied to sample the impressions and matching using the sampled impressions produces a solution, then the original graph has a matching that satisfies all orders to within a fraction 1−γ of their goals with probability at least 1−δ. This holds true for a scale factor ∈ that satisfies the inequality ∈≧(3 log(n/δ))/(γ̂2 Δ).

According to the foregoing, if the sampled data produces a matching solution then the un-scaled graph also has a matching solution with under-delivery at most 1−γ on any order. To maximize the matching, the goals of each order in the sample can be increased by a factor 1/(1−γ), and then scaling is performed for the orders and impressions as described above.

Step 206 applies one or more matching algorithms to the sampled data to match the scaled orders to the scaled impressions. For instance, given the sampled data set and/or scaled graph obtained in step 204, matching tool 116 may be implemented to apply various suitable matching algorithms. Generally, suitable matching algorithms accept the scaled graph or sampled data set as input and operate to match impressions to orders one to another by optimizing objective criteria. Examples of suitable matching algorithms include but are not limited to a balance algorithm, a learn weights algorithm, and a water-level algorithm, which are described in greater detail in relation to the following figures.

Step 208 determines a result of matching performed upon the sampled data and step 210 utilizes the result of matching for the sampled data to solve a matching problem corresponding to the un-scaled graph. As noted, the various matching algorithms can be applied offline in the context of determining whether to book orders (e.g., booking problems) and/or online in the context of determining how to deliver impressions to orders (e.g., delivery problems).

In the case of booking problems, matching involves determining whether sufficient inventory of impressions exists to fulfill the scaled orders. Assume now that the scaled graph created above is employed offline to solve a booking problem. A result of matching can be obtained per step 208 that indicates whether or not the scaled orders can be booked using the scaled impressions. Conclusions can be drawn regarding matching for the un-scaled graph based upon the result obtained for the sampled data and/or scaled graph.

In particular, if the result indicated that the scaled orders can be booked, then this result is utilized per step 210 to conclude that the un-scaled orders can be booked using the un-scaled impressions. On the other hand, if the result indicates that the scaled orders cannot be booked, then this result is utilized per step 210 to conclude that the un-scaled orders cannot be booked using the un-scaled impressions. In practice, this enables a relatively quick decision to be made as to whether or not to accept an order when an order is received. Note that in an offline setting, the traffic model 130 can be used to predict actual impressions based on impression data 132 that may describe historic traffic.

In the case of offline delivery problems, determining a result of matching can involve determining whether a sufficient allocation of impressions to the orders can be achieved. In particular, matching tool 116 can be configured to apply one or more matching algorithms to a sampled data set and obtain as a result a set of priorities to be associated with the scaled orders. The priorities established for the scaled orders can be utilized at delivery time to deliver actual impressions to the un-scaled orders. In general, the priorities can be established in various ways using any suitable algorithms including those described herein. Further discussion regarding example algorithms and techniques that may be employed to address delivery problems and/or booking problems can be found in relation the following figures.

Having described example procedures involving advertisement inventory matching, consider now specific implementation examples that can be employed with one or more embodiments described herein.

Advertisement Inventory Matching Implementation Details

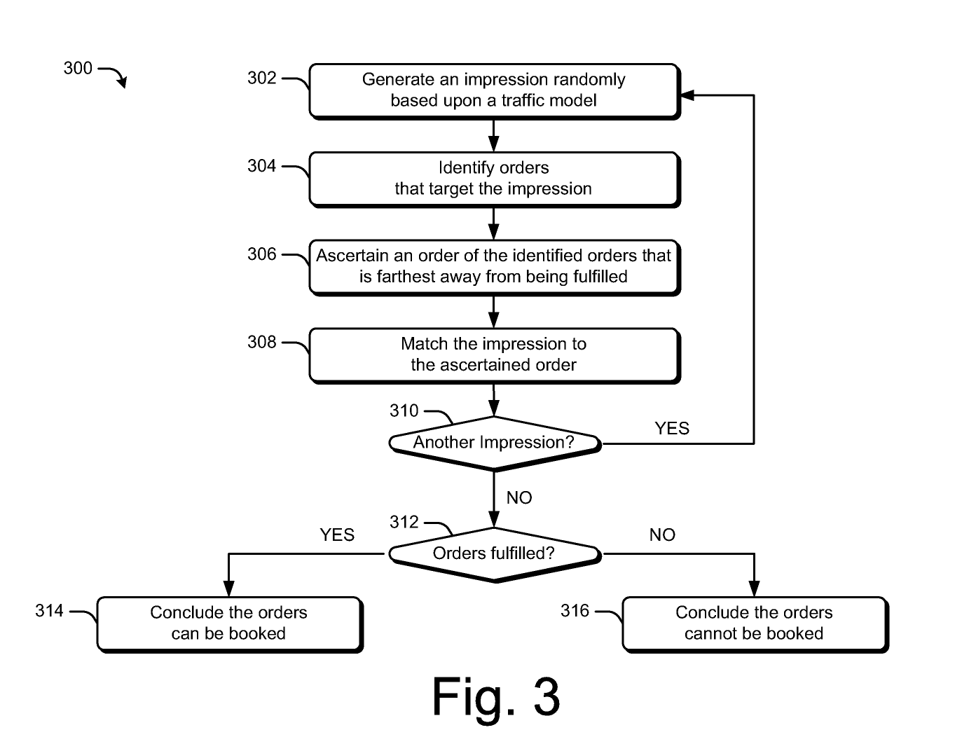

Consider now a discussion of example matching algorithms and implementations that may be employed using the previously described devices and systems. In particular, example matching algorithms are described just below in relation to corresponding procedures depicted in FIG. 3 to FIG. 5.

### Balance Algorithm

FIG. 3 is a flow diagram that describes another example procedure 300 in accordance with one or more embodiments. In at least some embodiments, the procedure 300 can be performed by a suitably configured computing device, such as a service provider 102 of FIG. 1 having a matching tool 116. In particular, FIG. 3 describes details of an example balance algorithm that can be applied by the matching tool 116 to a scaled graph to determine whether a set of orders can be booked. The balance algorithm discussed just below is one example of an algorithm that can be used for matching, such as matching that is discussed in relation to step 206 of procedure 200 of FIG. 2. The balance algorithm can be employed to determine if a prospective new order can be booked given a set of existing orders that have already been booked. To do so, the new order is added to the set of orders and matching tool 116 can conduct an offline simulation as follows.

Step 302 generates an impression randomly based upon a traffic model. In at least some embodiments, the matching tool 116 executes the balance algorithm to randomly select an impression from a scaled set of impressions as discussed in relation to FIG. 2. To do so, the matching tool 116 can be configured to make use of a traffic model 130. For instance, impression data 132 of the traffic model 130 can be sampled as described herein and then used to randomly simulate impressions based on historic traffic and/or statistical analysis. One way this can occur is by randomly generating impressions in the course of matching directly from the traffic model 130 according to a scale factor until a scaled number of impressions is reached. To be precise, let S be the set of impressions for a time period according to the traffic model. The impressions are generated by picking random impressions from the set S. In particular, the time that an impression corresponds to is also picked at random. In another example, a scaled graph or data set can first be constructed from the traffic model 130 and matching tool 116 can then perform matching techniques using the scaled data set.

In at least some embodiments, the impressions represent one or more keywords that relate to clients 124, activities of the clients 124, and/or properties of the clients 124. For example, keywords identified based on a search query such a search for “ESPN” may be used to match advertisements to webpages based on the keywords. In this case the keyword “Sports,” as well as other keywords, may be associated with the search for “ESPN.”

In another example, keywords and/or categories can be associated with content of webpages, such as pages of a sports related website or a page on a news site having a news story about a sports team or a particular sports personality. Display ads may be placed on such webpages according to keywords and/or categories that are associated with the content. Advertisers 120 can target the content based on how it is categorized (e.g., sports, news stories, business, entertainment, and so forth). To do so, advertisers 120 may designate and place orders for various combinations of keywords and/or categories for which they are interested in having their ads displayed. Advertisers 120 can also target attributes of the users who typically visit such pages. For instance, a client account that is used to access webpages and/or other resources may also be a source of keywords that relate to demographics, such as locations, genders, and/or ages of a user that views webpages and/or initiates the search.

In this context, an order may target a set number of impressions that relate to selected keywords, such as one hundred thousand impressions related to “Sports” and “Male.” To fulfill such an order from an advertiser 120, a service provider 102 can allocate reserved space for ads in webpages 128 that are served to clients 124 to present ads from the advertiser 120. In particular, the example order can be fulfilled by presenting webpages 128 having advertisements 122 from the advertiser 120 one hundred thousand times in response to page views, search queries, and/or other impressions that relate to “Sports” and “Male.” Because multiple advertisers 120 can target the same impressions, the matching for both booking and delivery problems considers how best to match particular impressions to particular orders so as to maximize matching.

Step 304 identifies orders that target the impression. As noted the matching tool 116 can implement a balance algorithm that operates upon sampled impressions and/or a scaled data set. In the preceding example, the matching tool 116 makes use of the balance algorithm to identify orders that target the example impression related to “Sports” and “Male.” The impression goals for these orders can be scaled according to the scale factor as described previously.

Step 306 ascertains an order of the identified orders that is farthest away from being fulfilled. Step 308 matches the impression to the ascertained order that is farthest away from being fulfilled. In other words, matching tool 116 can makes use of the balance algorithm offline to simulate delivery of randomly generated impressions to orders. To do so, the balance algorithm considers each impression in turn and matches it to the order that is farthest away from being fulfilled. A completion ratio defined as the ratio of impressions delivered to an order to the impression goal (e.g., total number of impressions) for the order can be calculated for each order that is being considered for a given impression. The impression is then delivered to an order having the lowest completion ratio (e.g., farthest away from being fulfilled) among the orders that target the impression.

After each impression is matched to an order, step 310 determines whether another impression exists to be matched. If there is another impression, procedure 300 returns to step 302 and the analysis of steps 302 to 308 to match the impression to an order is repeated for the next impression. This can occur until each impression has been analyzed. When impressions are generated directly from the traffic model 130, this may involve determining when a target number of impressions defined by the scale factor have been reached. When a data set that is scaled according to the scale factor is employed, then procedure 300 can operate until each impression of the scaled data set has been processed.

If another impression does not exist in step 310, procedure 300 proceeds to step 312. Step 312 determines whether each of the orders of the sampled and/or scaled data set has been fulfilled by the offline simulation. If the orders have been fulfilled, then step 314 concludes that the sample/scaled orders can be booked. On the other hand, if the sampled/scaled orders have not been fulfilled by the offline simulation, then step 316 concludes that the sampled/scaled orders cannot be booked. This can indicate for instance that the size of the prospective new order is too large. The conclusions that are made regarding the sampled/scaled orders can be employed to draw corresponding conclusions regarding the un-scaled orders, as discussed above in relation to procedure 200 of FIG. 2. More particularly, matching tool 116 can be configured to selectively enable or restrict booking of orders from advertisers according to conclusions made regarding whether the scaled orders are fulfilled using the scaled impressions. In general, the correlation made between the scaled and un-scaled orders is direct, such that conclusions made for the scaled orders hold for the un-scaled orders, and vice-versa.

Assuming now that an order cannot be booked according to step 312, the above approach to solving the booking problem can also be used to determine a maximum size of an order that can be booked. To do so, any of the matching algorithms described herein can be applied iteratively using a binary search approach. For example, if an order for ten million impressions cannot be booked, then the order size can be reduced by half to five hundred thousand, and the matching algorithm can be applied to the reduced order size. Now, if the reduced order can be booked, then the order size may be increased by one quarter of the original size to seven hundred and fifty thousand and the matching algorithm can be applied once again. Successive iterations using different order sizes can be made in this binary manner to quickly arrive at the maximum size of an order that can be booked. In this manner, matching tool 116 can be configured to implement a binary search that iteratively repeats matching of orders to the impressions to determine a maximum size of a new order that can be booked.

In another approach, a maximum size of an order can be determined using a one-step implementation. To do so, matching algorithms as described above and below can be applied with a modification. In particular, impressions that are assigned to a prospective new order during the simulation can be restricted such that the prospective new order is assigned a particular impression only when a condition is met that each other candidate order for the particular impression is ahead of its target. A number of impressions given to the prospective new order during the simulation are tracked. The scale factor used for the simulation can then be applied to “un-scale” the assigned number and output the impression goal for the order. The impression goal obtained corresponds to a maximum size of an order that can be booked.

### Water-Level Algorithm

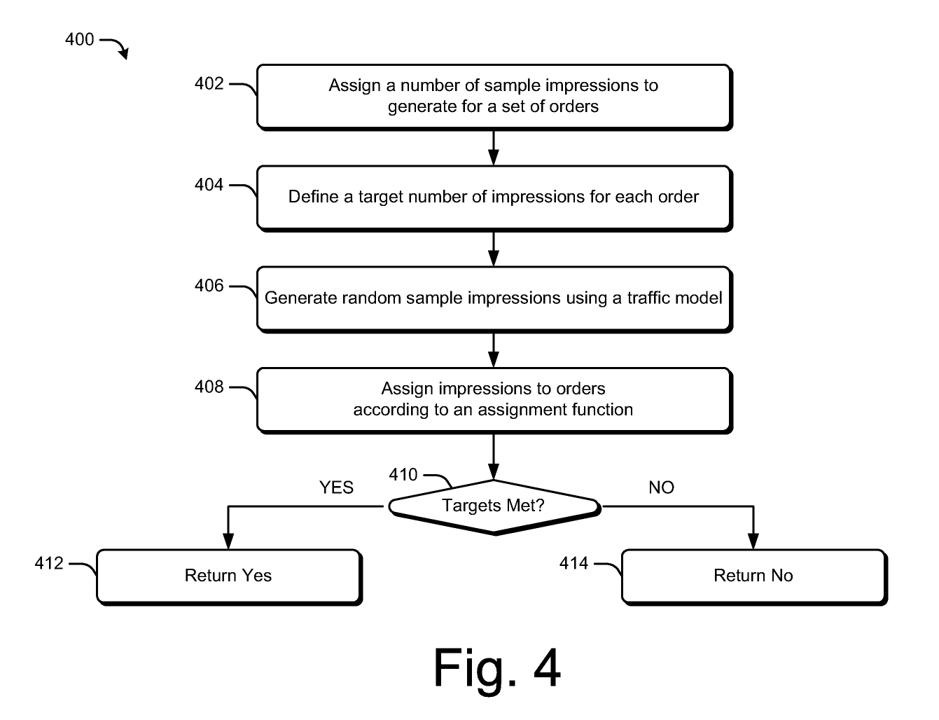

FIG. 4 is a flow diagram that describes another example procedure 400 in accordance with one or more embodiments. In at least some embodiments, the procedure 400 can be performed by a suitably configured computing device, such as a service provider 102 of FIG. 1 having a matching tool 116. In particular, FIG. 4 describes an example water-level algorithm that can be applied by the matching tool 116 to establish priorities that can be employed to determine how to deliver actual impressions to orders. The water-level algorithm discussed just below is one example of an algorithm that can be used for matching, such as matching that is discussed in relation to step 206 of procedure 200 of FIG. 2. Given a bipartite graph as discussed above, the water-level algorithm performs matching that can be used to solve both booking and delivery problems discussed herein. The water-level algorithm is defined as a streaming-like algorithm according to the framework that follows. The algorithm can be considered “streaming-like” in that it operates “online” to consider each impression and make an individualized decision regarding an order to which the impression is assigned. More particularly, the “streaming-like” algorithm decides to allocate an impression to an order based upon decisions that have been made for impressions that have already been considered. The differentiating factor between this model and traditional streaming algorithms is that the water-level algorithm is configured to know the number of impressions that are still to come.

The water-level algorithm is defined by specifying the choice of (1) a number of sample impressions m, a target kₒ of impressions for each order, and an assignment function. Generally speaking, a suitable assignment function operates to examine orders that target an impression and a number of remaining sample impressions, and then assigns the impressions to an order to optimize objective criteria. A variety of suitable assignment functions are contemplated. In at least some embodiments, the balance algorithm described herein can be employed as the assignment function to assign impression orders. In other words, the assignment can occur by assigning a given impression to an order that is farthest away from reaching its target kₒ.

Referring to FIG. 4, step 402 assigns a number of sample impressions to generate, m, and step 404 defines a number of target impressions, kₒ for each order o. Then, step 406 generates random samples of impressions from a set of impression I. This can occur using the traffic model 130 through operation of the matching tool 116. Step 408 assigns the impressions online (as they are generated) according to an assignment function f.

After each of the m samples has been generated, the number of impressions allocated to each order is examined. At step 410 a determination is made regarding whether the targets kₒ have been met. If each order has received at least the target number kₒ impressions, then at step 412 the water-level algorithm returns “Yes.” If each order has not received at least the target number kₒ impressions, then at step 414 the water-level algorithm returns “No.” The concept is that if a complete matching exists, then the algorithm should be able to achieve the given targets. On the other hand, if a near-complete matching does not exist, the algorithm may be unable to achieve the targets. The framework for the water-level algorithm can be expressed as follows:

Water-Level Framework
Initialize: k, m.
While m>0
   Get a random i ∈ I and Γ(i).
   a :=generic-step(Γ(i), k, m).
   Update k :=k−eₐ and m :=m−1. (eₐ is the unit vector with 1 in the a^{th} position and 0's elsewhere.)
If k≦0, output YES
Else output NO

A general class of single generic steps for the above framework can be formulated and are called water-level steps. The resulting algorithms are called water-level algorithms. An example water-level algorithm, applicable at least when the size of each order is the same, assigns an impression to an order that has the highest remaining target. This example algorithm can be expressed as follows:

Water-Level Step with Potential Function f(k,m)
Given: current k, m and Γ(i).
Assign i to a=arg min_{a′}∈_{Γ(i)}{f(k−e_{a′}, m−1)}. In other words, assign the impression i to an a in its neighborhood, such that the function f on the resulting target is minimized.

In at least some embodiments, the water-level algorithm can be applied offline to scaled orders and impressions using the traffic model 130. By examining the number of impressions allocated to orders by the water-level algorithm during its operation one can derive a schedule for delivery of the impressions online.

Now, assume that an actual impression is received from a client 124 by a service provider 102. In one example, this can occur in response to a search conducted via the client 124 through a search service. In another example, this can occur in response to a user navigating to view a webpage that is available from a service provider 102 to serve display ads to clients 124. One of the different rankings obtained through application of the water-level algorithm can be selected at random in accordance with the probabilities or weightings. In other words, the number of chances that a particular ranking has to be selected corresponds to its associated probability. The received impression is then allocated to the highest ranking order that is eligible to receive the impression, (e.g., the order targets the impression).

In some embodiments, the output of the balance and/or water-level algorithms just described can be used to compute a delivery schedule that can be implemented to allocate actual impression to orders “online.” To do so, a number of impressions assigned to each order during offline simulations can be tracked. The tracking can measure the number of impressions that are assigned for each hour, each day, and/or any other suitable time period. A scale factor used for the simulations can be applied to “un-scale” the track numbers to create periodic goals for each order. The matching tool 116 can be configured to implement a delivery schedule based on the periodic goals and utilize the delivery schedule to determine how to allocate impressions to ads online. For example, the delivery schedule can be used to determine orders that are farthest behind their respective periodic goal and assign impression accordingly.

### Learn Weights Algorithm

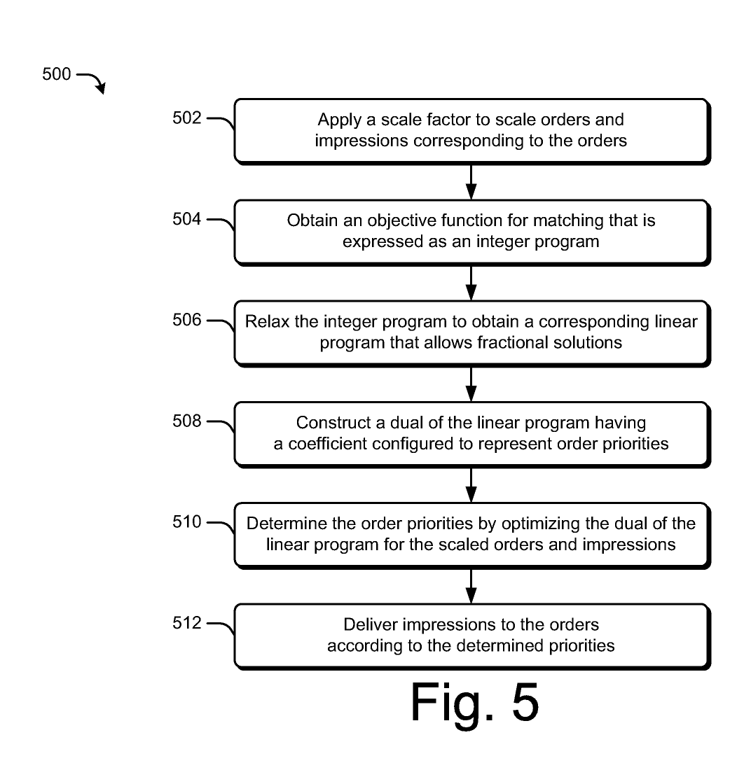

FIG. 5 is a flow diagram that describes another example procedure 500 in accordance with one or more embodiments. In at least some embodiments, the procedure 400 can be performed by a suitably configured computing device, such as a service provider 102 of FIG. 1 having a matching tool 116. In particular, FIG. 5 describes an example learn weights algorithm that can be applied by the matching tool 116 to establish priorities that can be employed to determine how to deliver actual impressions to orders. The learn weights algorithm discussed just below is one example of an algorithm that can be used for matching, such as matching that is discussed in relation to step 206 of procedure 200 of FIG. 2.

Step 502 applies a scale factor to scale orders and impressions corresponding to the orders. In particular, matching tool 116 can be implemented to sample a fraction e of traffic for the traffic model 130 and use a linear program (LP) to optimally allocate this traffic to orders whose impression goals are scaled by the same fraction ∈. In at least some embodiments, the matching tool 116 implements the learn weights algorithm to determine priorities (e.g., weights) associated with orders and then uses the learned priorities online at delivery to allocate impressions to orders.

Step 504 obtains an objective function for matching that is expressed as an integer program. The matching tool 116 can be configured to include the objective function, construct the objective function, and/or otherwise obtain the matching the objective function. The objective function here expresses an optimal way to match orders to impressions. In at least some embodiments, the objective function can be formulated as an integer program based upon the offline booking problem discussed herein.

To obtain this integer program, let the index variable i range over a set of impressions I and j range over a set of orders O. The variable xᵢⱼ ∈ {0,1} tracks whether the ith impression was delivered to the order j or not (e.g., it is set to 1 if it was delivered to j and 0 if it wasn't). The variable uᵢⱼ is either 1 or 0 representing whether the impression i can be delivered to j or not (e.g., does the order j target impression i). If gⱼ is the goal of the order j, then the offline delivery problem can be described by the following integer program:

$$max {\sum }_{i , j} {u}_{ij} {x}_{ij}$$

$$such that ∀ j : {\sum }_{i} {u}_{ij} {x}_{ij} \leq {g}_{j}$$

$$such that ∀ i : {\sum }_{j} {x}_{ij} \leq 1$$

$${x}_{ij} ∈ \{ 0 , 1 \}$$

Step 506 relaxes the integer program to obtain a corresponding linear program (LP) that allows fractional solutions. Consider the LP relaxation of the above integer program that enables the xᵢⱼ's to take on fractional values. In other words, relax the condition of xᵢⱼ ∈ {0,1} to 0≦xᵢⱼ≦1. The fractional and integral optima are close to each other. Thus, the relaxed LP can be used instead of solving the more difficult integer program.

Accordingly, step 508 constructs a dual of the linear program having a coefficient configured to represent order priorities. In particular, the duality of the LP can be used to obtain the optimum solution by constructing a dual of the relaxed LP. This involves a mechanical mathematical translation of the LP to obtain the corresponding dual. The dual of the program can be expressed as:

$$min {\sum }_{j} {α}_{j} {g}_{j} + {\sum }_{i} {p}_{i}$$

$$such that ∀ i , {jp}_{i} \geq {u}_{ij} ( 1 - {α}_{j} )$$

Since the dual is less complex to solve, the dual of the LP is used to establish a set of priorities for each order. The impressions can be delivered to the orders based on these learned priorities. This approach is asymptotically the optimal online delivery algorithm.

Step 510 determines the order priorities by optimizing the dual of the linear program for the scaled orders and impressions. At the optimum of the dual linear program, it follows that ∀i:pᵢ=maxⱼuᵢⱼ(1−αⱼ). The solution of the dual establishes values for αⱼ, e.g., the priorities. These priorities can then be employed to allocate each impression i to the order j that maximizes uᵢⱼ(1−αⱼ).

Thus, one can think of the dual objective as just a function of the αⱼ's. It follows that:

$$D ( α ) = {\sum }_{j} {α}_{j} {g}_{j} + {\sum }_{i} {max}_{j} {u}_{ij} ( 1 - {α}_{j} )$$

By complimentary slackness, if (α,p) minimizes the dual LP, and x is the optimal allocation to the primal LP, then:

$${x}_{ij} > 0 implies {p}_{i} > {max}_{j} {u}_{ij} ( 1 - {α}_{j} )$$

Therefore, given the optimal α, an impression i is allocated to an order that maximizes uᵢⱼ(1−αⱼ). To do so, weight of (1−αⱼ) can be calculated from the priorities and used as multiplicative discount factors for the orders. In at least some embodiments, the traffic model 130 can be used to obtain the priorities offline using simulated impressions. The priority values obtained offline can then be used to perform online delivery.

Additionally or alternatively, the values of the αⱼ's can be obtained online using an initial fraction of the impressions to guess the priorities. While the priorities are initially being learned, the impressions can be allocated randomly. Once the priorities are established, the remaining impressions are allocated according to the priorities that are determined online. In particular, an impression can be allocated to an order j that maximizes uᵢⱼ(1−αⱼ).

Step 512 delivers impressions to the orders according to the determined priorities. As noted the priorities can be determined using online or offline techniques. Online delivery of actual impression can then occur in accordance with the learned priorities. In particular, a given impression is allocated to an order that has the highest priority. Then, an advertisement 122 from an advertiser 120 corresponding to the order can be shown in a webpage 128 that is served by a service provider 102 to a client 124 in response to a search query or other input that produces the impression.

Having described example implementation details regarding advertisement inventory matching, consider now an example system that can be employed to implement aspects of the described techniques.

### Example System

FIG. 6 illustrates generally at 600 an example computing device 602 that may implement the various embodiments described above. The computing device 602 may be, for example, a client 124 of FIG. 1, a server of a service provider 102, a server of an advertiser 120, or any other suitable computing device.

The computing device 602 includes one or more processors or processing units 604, one or more memory and/or storage components 606, one or more input/output (I/O) interfaces 608 for input/output (I/O) devices, and a bus 610 that allows the various components and devices to communicate one to another. The bus 610 represents one or more of several types of bus structures, including a memory bus or memory controller, a peripheral bus, an accelerated graphics port, and a processor or local bus using any of a variety of bus architectures. The bus 610 can include wired and/or wireless buses.

The memory/storage component 606 represents one or more computer storage media. The memory/storage component 606 may include volatile media (such as random access memory (RAM)) and/or nonvolatile media (such as read only memory (ROM), Flash memory, optical disks, magnetic disks, and so forth). The memory/storage component 606 may include fixed media (e.g., RAM, ROM, a fixed hard drive, etc.) as well as removable media (e.g., a Flash memory drive, a removable hard drive, an optical disk, and so forth).

The one or more input/output interfaces 608 allow a user to enter commands and information to computing device 600, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may comprise “computer-readable storage media.”

Software or program modules, including the matching tool 116, applications 108, service manager module 112, operating system 110, and other program modules, may be embodied as one or more instructions stored on computer-readable storage media. The computing device 602 may be configured to implement particular functions corresponding to the software or program modules stored on computer-readable storage media. Such instructions may be executable by one or more articles of manufacture (for example, one or more computing device 602, and/or processors 604) to implement techniques for advertisement inventory matching, as well as other techniques. Such techniques include, but are not limited to, the example procedures described herein. Thus, computer-readable storage media may be configured to store instructions that, when executed by one or more devices described herein, cause various techniques for advertisement inventory matching

The computer-readable storage media includes volatile and non-volatile, removable and non-removable media implemented in a method or technology suitable for storage of information such as computer readable instructions, data structures, program modules, or other data. The computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or another tangible media or article of manufacture suitable to store the desired information and which may be accessed by a computer.

Conclusion

Although the invention has been described in language specific to structural features and/or methodological steps, it is to be understood that the invention defined in the appended claims is not necessarily limited to the specific features or steps described. Rather, the specific features and steps are disclosed as example forms of implementing the claimed invention.

1. A computer-implemented method comprising:
obtaining a bipartite graph that connects orders to impressions with edges between vertices that represent the orders and vertices that represent the impressions;
creating a scaled graph by scaling both the impressions and the orders according to a scale factor;
applying one or more matching algorithms to the scaled graph to match the scaled orders to the scaled impressions;
determining a result of matching performed upon the scaled graph; and
utilizing the result of matching for the scaled graph to solve a matching problem corresponding to the un-scaled graph.

2. The computer-implemented method of claim 1, wherein applying the one or more matching algorithms occurs offline using a traffic model.

3. The computer-implemented method of claim 1, wherein applying the one or more matching algorithms occurs online using actual impressions as they are being received from one or more clients.

4. The computer-implemented method of claim 1, wherein determining the result of matching comprises concluding whether or not the orders as scaled can be booked using the impressions as scaled.

5. The computer-implemented method of claim 4, wherein utilizing the result of matching for the scaled graph to solve the matching problem corresponding to the un-scaled graph comprises:
concluding that the orders for the un-scaled graph can be booked if the orders as scaled can be booked using the impressions as scaled; and
concluding that the orders for the un-scaled graph cannot be booked if the orders as scaled cannot be booked using the impressions as scaled.

6. The computer-implemented method of claim 1, wherein determining the result of matching comprises establishing priorities assigned to the orders that enable online delivery of actual impressions as they are being received from one or more clients according to the determined priorities.

7. The computer-implemented method of claim 6, wherein utilizing the result of matching for the scaled graph to solve the matching problem corresponding to the un-scaled graph comprises:
obtaining an impression from a client based upon a search conducted by the client using a search service;
allocating the impression to an order based upon the established priorities; and
outputting a webpage in response to the search that includes an advertisement from an advertiser corresponding to the order.

8. The computer-implemented method of claim 1, wherein applying one or more matching algorithms to the scaled graph to match the scaled orders to the scaled impressions comprises applying a balance algorithm configured to:
generate an impression randomly based upon a traffic model;
identify orders that target the impression;
ascertain an order of the identified orders that is farthest away from being fulfilled; and
match the impression to the ascertained order.

9. The computer-implemented method of claim 1, wherein applying one or more matching algorithms to the scaled graph to match the scaled orders to the scaled impressions comprises applying a learn weights algorithm configured to establish priorities associated with each order by at least:
expressing an objective function configured to represent optimal booking of the orders as a linear program;
constructing a dual of the linear program; and
establishing the priorities associated with each order by optimizing the dual of the linear program.

10. The computer-implemented method of claim 1, wherein:
applying one or more matching algorithms to the scaled graph to match the scaled orders to the scaled impressions comprises applying a water-level algorithm configured to establish multiple different rankings of the orders one to another and probabilities associated with each ranking; and
utilizing the result of matching for the scaled graph to solve a matching problem corresponding to the un-scaled graph comprises delivering an impression to an order online by:
obtaining the impression from a client;
selecting one of the multiple different rankings at random in accordance with the probabilities; and
allocating the received impression to the highest ranking order in the selected ranking that targets the impression.

11. One or more computer-readable storage media storing instructions that, when executed by one or more server devices, cause the one or more server devices to implement a matching tool configured to:
sample a traffic model to generate impressions randomly according to a scale factor until a target number of impressions defined by the scale factor is reached;
for each impression that is generated:
identify orders that target the impression, the orders being scaled according to the scale factor;
ascertain an order of the identified orders that is farthest away from being fulfilled; and
match the impression to the ascertained order.

12. One or more computer-readable storage media of claim 11, wherein the matching tool is further configured to:
determine whether orders as scaled are fulfilled using the impressions that are generated;
if the orders are fulfilled, enable booking of the orders from the advertisers; and
if the orders are not fulfilled, restrict booking of the orders from the advertisers.

13. One or more computer-readable storage media of claim 11, wherein to ascertain an order that is farthest away from being fulfilled comprises:
calculating a completion ratio for each identified order, the completion ratio defined as a ratio of impressions delivered to a particular order to a total number of impressions for the particular order; and
identifying an order having a lowest completion ratio among the identified orders that target the impression.

14. One or more computer-readable storage media of claim 11, wherein the impressions represent one or more keywords related to interactions of a client with a service provider to obtain resources available from the service provider.

15. One or more computer-readable storage media of claim 11, wherein the matching tool is further configured to:
determine based upon matching of the orders to the impressions that the orders cannot be booked; and
conduct a binary search that iteratively repeats matching of the orders to the impressions to determine a maximum size of an order that can be booked.

16. A computing system comprising:
one or more processors; and
computer readable storage media having one or more modules stored thereon, that, when executed via the one or more processors, cause the computing system to perform acts including:
obtaining an objective function for matching impressions to orders for the impressions that is expressed as an integer program;
relaxing the integer program to obtain a corresponding linear program that allows fractional solutions;
construct a dual of the linear program having a coefficient configured to represent priorities for the orders;
determining the priorities for the orders by optimizing the dual of the linear program for matching the impressions to the orders; and
delivering impressions to the orders according to the determined order priorities.

17. The computer system of claim 16, wherein the relaxed integer program produces a linear program of the form: maxΣ_{i,j}uᵢⱼxᵢⱼ, where ∀j:Σᵢuᵢⱼxᵢⱼ≦gⱼ and ∀i:Σⱼxᵢⱼ≦1 and 0≦xᵢⱼ≦1.

18. The computer system of claim 17, wherein the dual of the linear program is expressed as: minΣⱼαⱼgⱼ+Σᵢpᵢ such that ∀i,jpᵢ≧uᵢⱼ(1−αⱼ).

19. The computer system of claim 18, wherein:
determining the order priorities comprises solving the dual of the linear program to establish the values of αⱼ; and
delivering the impressions to the orders according to the determined order priorities comprises allocating each impression i to the order j that maximizes uᵢⱼ(1−αⱼ) based on the values established for αⱼ.

20. The computer system of claim 16, wherein the orders for impressions enable advertisers to place advertisements for presentation to clients in conjunction with resources provided by a service provider to the clients based on the impressions.
